(19) United States
(12) Patent Application Publication
(10) Pub. No.: US 2007/0284063 A1
(43) Pub. Date: Dec. 13, 2007

(54) Table utility bay door assembly

(76) Inventors: Bryan Keith Elwood, Arlington, TX (US); Michael J. Shawver, Pleasenton, CA (US)

Correspondence Address: QUARLES & BRADY LLP, 411 E. WISCONSIN AVENUE, SUITE 2040, MILWAUKEE, WI, 53202-4497, US

(21) Appl. No.: 11/448,511

(22) Filed: Jun. 7, 2006

(51) Int. Cl. E06B 3/12

(52) U.S. Cl. 160/218

(57) ABSTRACT

A door assembly for use with a table top member that forms a table opening, the assembly including a support member mounted to the table top member, a first door member supported by the support member for pivotal movement between a closed position blocking at least a first portion of the table opening and an open position, a second door member supported by the support member for pivotal movement between an closed position blocking at least a second portion of the table opening and an open position, a single biaser supported by the support member and linked to each of the first and second door members to independently bias each of the first and second flapper members toward the open positions.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to table mounted power and communication utility bays and more specifically to a utility bay configuration that includes a biaser that assists in opening of a bay door.

Function, aesthetics, cost and durability are the most important factors to consider when designing a conference or multi-person table. With respect to function, conference tables are typically designed to accommodate people on multiple table sides so that people attending a conference can generally face one another when communicating. In addition, because people often slide objects (e.g., paper, laptops, etc.) across table tops, optimally, a table configuration includes structure that forms a completely flat and uni-planar surface so that object sliding is substantially unobstructed. For instance, even a small upward extending lip along the center line of a table top would obstruct movement there across and therefore would be bothersome. Moreover, conference or large multi-person table users often use laptops and other electronic devices at the tables and therefore require or at least desire power and data hookups at the tables.

One solution for providing power and data for use at tables has been to integrate easily accessible power and data receptacles into table configurations. For instance, in the case of an elongated conference table that includes a top member that forms a top surface and an oppositely facing undersurface, many such table top members form one or more openings along a central line and include separate utility (e.g., power and/or data) bays or structure below the undersurface for mounting one or more power and/or data receptacles. Here, power and data cords are fed up from a table supporting floor and through leg or other channel defining structure to the top member undersurface and to the receptacles. To link to the utility bay receptacles, cables are fed from laptops and the like into the centrally located utility bays. To hide excess cable lengths, often utility bays are formed with cavity forming structure that receives and supports excess cable lengths generally below the table top.

With respect to aesthetics, receptacles and excess cable are typically considered unsightly and therefore many table configurations that includes utility bays also include one or two utility bay doors per utility bay for blocking sight lines through top member openings and into utility bays there below. Here, the bay doors are usually mounted to pivot between open and closed positions in which access to the receptacles is facilitated and blocked, respectively. In the closed position the doors are typically parallel to and at least somewhat aligned with a top member top surface. In the open position, the doors usually swing upward above the top surface or fold downward at least partially into the opening to reveal receptacle outlets.

In some cases bay doors are dimensioned so that, when in the closed positions, a cable accommodating gap is provided between at least one edge of the door member and an adjacent edge of the table top opening so that the door can be in the closed position even when one or more cables passes through the opening to the utility bay receptacles. Here, to link a cable to a receptacle, the bay door is opened so that an enlarged cable end plug can be placed through the opening and into the bay. After linking the plug to a suitable outlet, the door is closed to block view into the bay with the cable passing through the gap. To further block lines of sight through the gap, some configurations include a rubber lip or a line of resilient bristles along the door edge that can deform to accommodate cables while still forming a visual barrier within the gap.

Also, with respect to aesthetics, many tables are designed to have minimal seams in the top surfaces so that the top surfaces have sleek and uniform appearances. Here, table top openings generally disrupt the sleek appearance of a top surface and therefore, in some cases, the number of openings is minimizes. For instance, where two people at a table face each other from opposite table sides, instead of providing a separate opening for each of the two table users, in many cases a single opening is provided where an undersurface bay includes a number of receptacles sufficient to accommodate all of the power and data needs of the two facing table users.

At least some bay door configurations are designed to help a user open and keep the doors when desired. To this end, some bay door configurations include gas springs or the like that, when activated, drives the doors into the open positions. For instance, where a door pivots about a rear edge hinge from a horizontal closed position into a substantially vertical open position, a gas spring may be supported at one end by structure below the top member, linked at the opposite end to the undersurface of the door member and oriented substantially perpendicular to the top member (i.e., perpendicular to the door member when the door member is in the closed position). Here, when the spring is allowed to expand, a spring shaft extends upward forcing the door member to pivot about the hinge and into the open position.

While the bay door configurations described above help to block unsightly receptacles and excess cable lengths, unfortunately known configurations usually have one or more shortcomings. For example, many door designs require at least some mounting or support structure to reside above a top member top surface. For instance, in many cases a bezel member includes a grommet and lip structure that rests on the portion of a top surface that surrounds an opening. Here, the bezel member resides above the top surface and therefore obstructs sliding action across the top surface.

As another example, where a bezel or other structure in addition to the top surface of a bay door member is visible from above a top member, the seams between the door member and other structure disrupt the sleek table top appearance. For instance, in the case of a door member surrounded by a bezel, at a minimum, a first seam appears between the outer edge of the bezel and the surrounding table top member and a second seam appears between the door member and the bezel. As another instance, where two door members are separated by a spine member to close a single opening, seams appear between each door and the spine member as well as between each door and the surrounding table top member. Similarly, rubber and bristle gap blocking structure breaks up the appearance of a table top.

As one more example, many bay door configurations are designed to accommodate only a single table thickness. For instance, in many cases, door configuration mounting structure includes components (e.g., a bezel and brackets) that embrace both the top surface and the undersurface of a top member where the relative positions of the components is not adjustable. Here, where a design is to be used with multiple thickness table tops, multiple different versions of the design are required with differently dimensioned components for each of the thicknesses. Any time multiple versions of a product configuration are required, costs increase appreciably.

As still one other example, where opening springs are provided to assist in opening bay doors, in known configurations, a separate spring is required for each bay door. Thus, for instance, where two doors are provided to close a single opening, two separate springs are required, one for each of the separate doors. In general more parts increase configuration costs and therefore configurations that require two springs are less optimal than configurations that include a single spring. In addition, in known configurations, the biasing springs are usually aligned so that they extend at least somewhat perpendicular to the doors that the springs open when the doors are closed. The space below the table top member required to accommodate the perpendicularly oriented springs means that the door configuration has to extend well below the undersurface of the top member which either reduces the amount of space within a bay for receptacles and excess power and data line storage or requires that the bay extend further below the undersurface to accommodate required receptacles.

### BRIEF SUMMARY OF THE INVENTION

It has been recognized that a linkage can be provided between a gas spring shaft and a utility bay door that changes the trajectory of shaft force so that a gas spring that expands substantially parallel to a top member top surface can open a bay door by applying a force that is substantially perpendicular to the top surface so that the dimension of the space below a top member required to accommodate the spring can be minimized. In the illustrated embodiment described hereafter a pivoting crank link is used to change the trajectory of the applied force.

In addition, it has been recognized that a single dual shaft gas spring (i.e., a spring including oppositely extending shafts) can be provided to independently open two utility bay doors where each shaft is linked to a separate one of the door members by way of trajectory altering members. By using a single spring for two doors, cost is minimized and the space required to accommodate the door driving force mechanism is minimized.

Moreover, it has been recognized that a two bay door configuration can be provided that has an extremely sleek appearance. In this regard, a door configuration including two pivoting doors can be mounted to structure below a table top member top surface where the doors are flush with the top surface of the top member and where the edges of the door members are immediately adjacent the edge surfaces of the top member that forms an accommodating opening. Here, in at least some embodiments, a grommet cover may be provided in an opening to provide a finished appearance to the opening forming surface. In this case, the phrase immediately adjacent the opening surface means immediately adjacent the internal surface of the grommet.

Furthermore, it has been recognized that a door adjustment mechanism can be provided as part of a door configuration for adjusting the height of a closed door assembly within a top member opening so that a single configuration can be used with table tops of various thicknesses. Here, in at least some embodiments, jack screws are provided that can be rotated to raise or lower closed door height so that the top surfaces of bay doors can be made flush with the top surface of a table top member.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE SEVERAL VIEWS OF THE DRAWINGS

FIG. 1 is a perspective view of the utility bay door assembly according to at least one inventive embodiment;

FIG. 2 is a top plan view of the assembly of FIG. 1 installed in an opening formed by a table top member;

FIG. 3 is a partial cross-sectional view taken along the line of 3-3 of FIG. 2;

FIG. 4 is a partial cross-sectional view taken along the line 4-4 of FIG. 2;

FIG. 5 is a perspective view similar to the view of FIG. 1, albeit showing door subassemblies in an open position as opposed to a closed position;

FIG. 6 is similar to FIG. 4, albeit showing door subassemblies in open positions;

FIG. 7 is a perspective view of a hinge support shown in FIG. 3;

FIG. 8 is a top plan view of the hinge support member of FIG. 7;

FIG. 9 is a perspective view of a T-bracket assembly that forms a portion of the assembly of FIG. 1;

FIG. 10 is an exploded view of the assembly of FIG. 9;

FIG. 11 is a perspective view of a lifter housing that forms a portion of the assembly of FIG. 1;

FIG. 12 is a perspective exploded view of one of the door assemblies of FIG. 1;

FIG. 13 is a second exploded perspective view of the door subassembly of FIG. 12;

FIG. 14 is a perspective view of a V-bracket subassembly that forms a portion of the assembly of FIG. 1;

FIG. 15 is a top plan view of the subassembly of FIG. 14;

FIG. 16 is a perspective view of first and second force transfer/latch subassemblies and a gas spring subassembly that form a portion of the assembly of FIG. 1;

FIG. 17 is a side view of the first force transfer/latch subassembly of FIG. 16 where the components are in a closed door orientation;

FIG. 18 is a perspective exploded view of the subassembly of FIG. 17;

FIG. 19 is similar to FIG. 17, albeit showing the components in a door depressed orientation;

FIG. 20 is similar to FIG. 17, albeit showing the components in a door open orientation;

FIG. 21 is a perspective view of a lifter pad that forms part of the subassembly of FIG. 17;

FIG. 22 is a perspective view of the gas spring of FIG. 16; and

FIGS. 23a through 23d show top plan views of other exemplary and additional embodiments that are consistent with at least some inventive aspects.

### DETAILED DESCRIPTION OF THE INVENTION

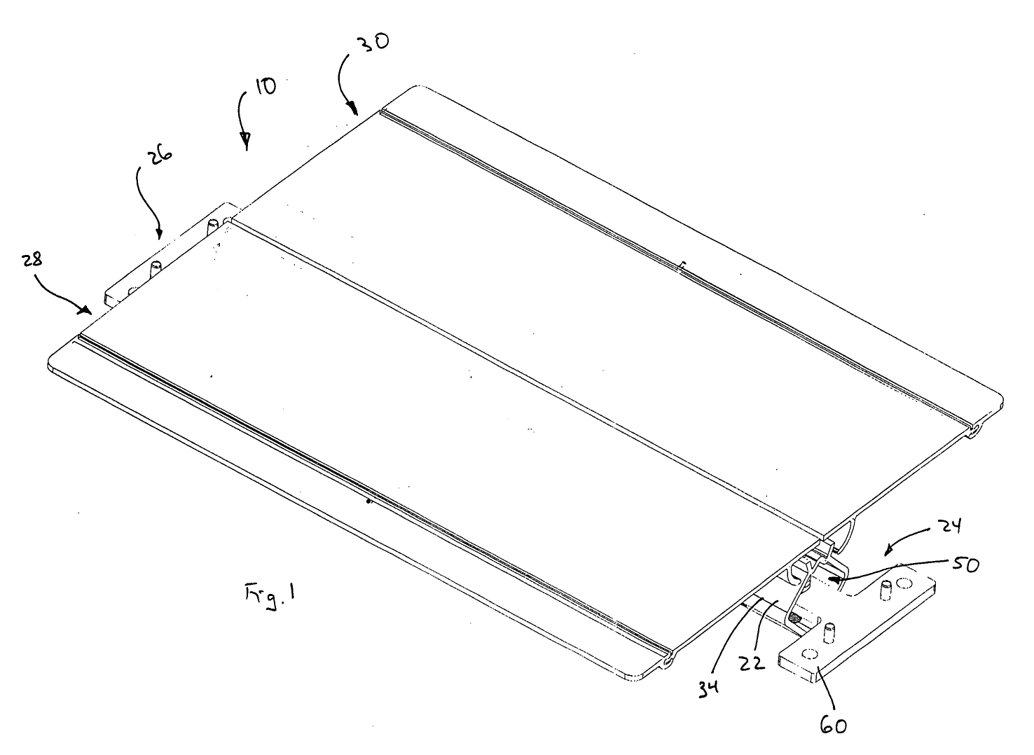

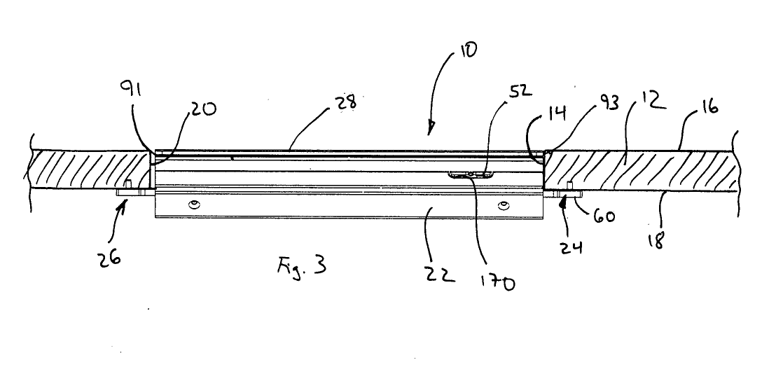

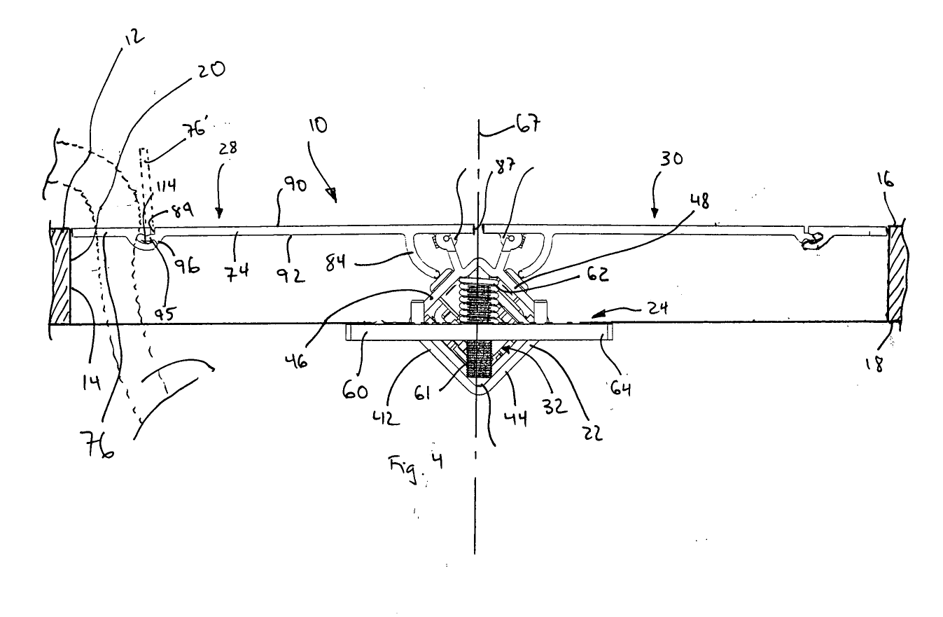

Referring now to the drawings wherein like reference characters and numerals correspond to similar elements throughout the several views and, more specifically, referring to FIGS. 1-6, the present invention will be described in the context of an exemplary utility bay door assembly 10 that is mounted to a table top 12 to optionally close or open an opening 14 formed by the table top member 12. To this end, as best seen in FIGS. 3 and 4, top member 12 includes oppositely facing to or upper surface 16 and bottom or under surface 18 and an opening 14 defined by an opening edge surface 20 which extends through member 12. Among other components, assembly 10 includes a flapper hinge support 22, a first T-bracket assembly 24, a second T-bracket assembly 26, a first door assembly 28, a second door assembly 30 and an open assist assembly 32.

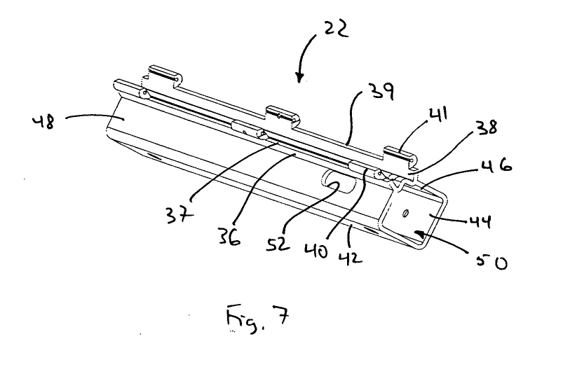

Referring now to FIGS. 1, 4, 7 and 8, flapper hinge support 22 includes an elongated tubal member 34 and a plurality of arm members (e.g., first arm member 36, second arm member 38, etc.) that extend therefrom. Tube member 34 has a generally square cross-sectional profile as best seen in FIG. 4 including first and second lower wall member 42 and 44 and first and second upper wall members 46 and 48, respectively. First lower wall member 42 is substantially parallel to second upper wall member 48 and is spaced apart therefrom while second lower wall member 44 is substantially parallel to and spaced apart from first upper wall member 46 so that the wall members 42, 44, 46 and 48 together define a channel 50 (see FIG. 7). Proximate the integrally connected edges of upper wall members 46 and 48 arm members 36 and 38 extend from the external surfaces of wall members 46 and 48, respectively. Each of the arm members 36 and 38 extend along the entire length of tube member 34 and, at distal ends 37 and 39 thereof, respectively, a plurality of hinge couplers 40 and 41 are formed. In the illustrated embodiment, three equi-spaced hinge couplers 40 are located along distal edge 37 of arm member 36 and, similarly, three hinge couplers 41 are equi-spaced along the length of distal edge 39.

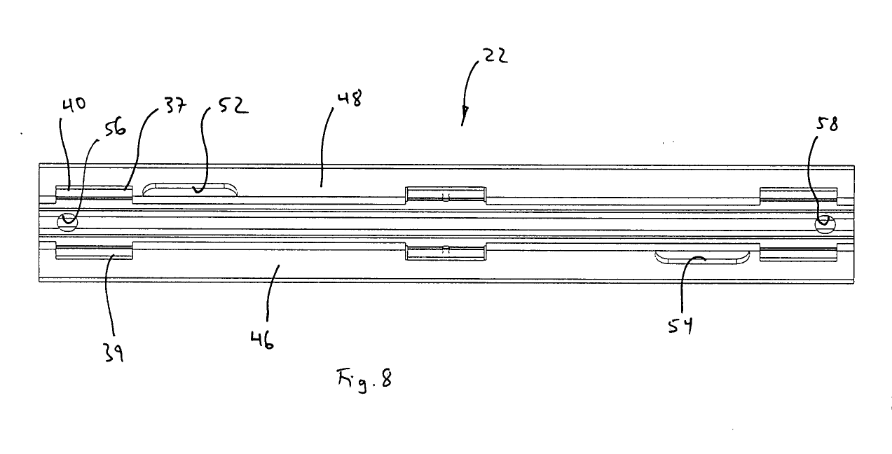

Referring still to FIGS. 7 and 8, tube member 34 forms several openings that are functionally important to the illustrated embodiment. More specifically, proximate one end, upper wall 48 forms a flattened oval opening 52 (see also FIG. 3). Similarly, proximate the second end of member 34, upper wall 46 forms a flattened oval opening 54. As best seen in FIG. 8, along the edge where upper walls 46 and 48 are connected, member 34 forms first and second adjustment openings 56 and 58 that extend through member 34 and into channel 50.

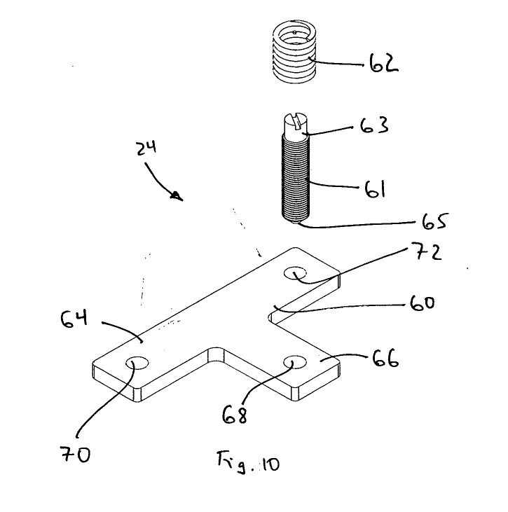

Referring once again to FIG. 1, T-bracket assemblies 24 and 26 have similar configurations and operate in a similar fashion and therefore, in the interest of simplifying this explanation, only T-bracket assembly 24 will be described here in detail. Referring also to FIGS. 4, 9 and 10, assembly 24 includes a T-bracket member 60, a jack screw 61 and a compression spring 62. T-bracket member 60 is an integrally formed member including an elongated member 64 and a central extending member 66 that extends from a mid-section of elongated member 64 and to one side thereof. Near a distal end, central extending member 66 forms a threaded opening 68. Near distal ends, elongated member 64 forms first and second screw passing apertures or openings 70 and 72. Jack screw 61 is an elongated screw member having first and second oppositely extending ends 63 and 65, respectively. The external surface of screw 63 is threaded so as to be receivable within threaded aperture 68. At end 63 screw 61 is keyed to receive an adjustment screw (e.g., a screw driver). When screw 61 is received in aperture 68, when screw 61 is turned, the screw 61 moves along a jack screw axis 67 (see again FIG. 4) perpendicular to T-bracket member 60. Compression spring 62 forms a spring channel (not labeled) dimensioned so that the first end 63 of jack screw 61 is receivable therein.

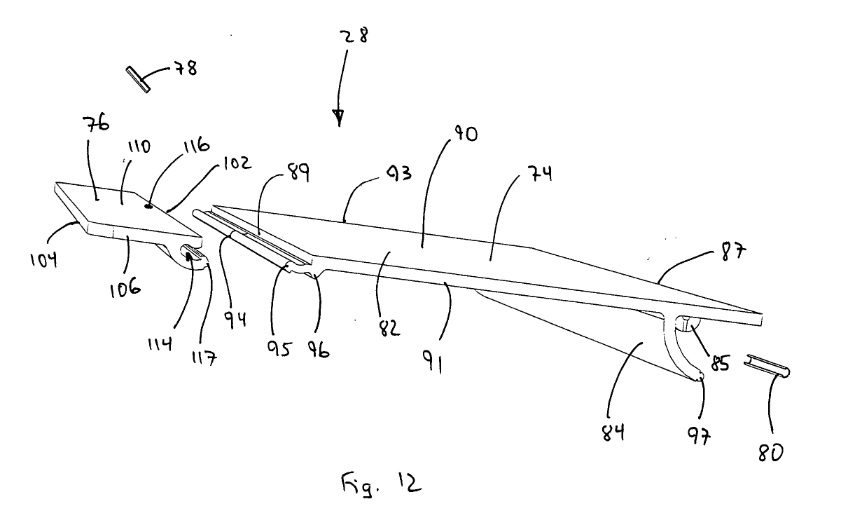

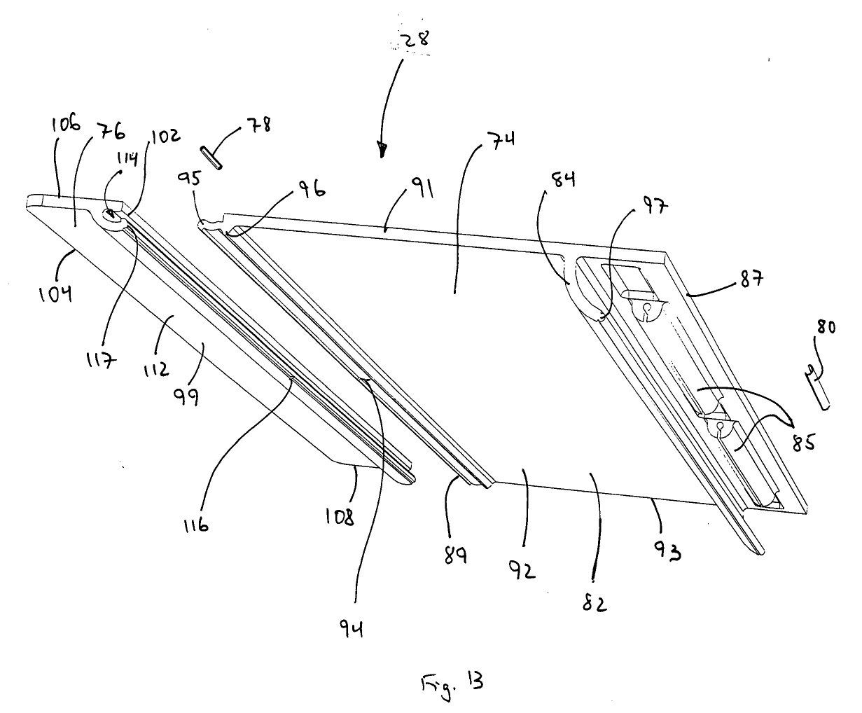

Referring once again to FIG. 1, each of the first and second door assemblies 28 and 30 have similar configurations and operate in a similar manner and therefore, in the interest of simplifying this explanation, only first door assembly 28 will be described here in detail. Referring also to FIGS. 12 and 13, door assembly 28 includes a main door member 74, an edge flapper member 76, a roll pin 78 and a wear pad 80. Main door member 74 includes a flat rectilinear member 82, an arm member 84 and a hinge coupler 85. Member 82 includes oppositely facing top and under surfaces 90 and 92, respectively, oppositely facing and parallel front and rear edges 89, 87, respectively, and first and second oppositely facing and parallel lateral edges 91 and 93, respectively. Here, while rear and front edges 87 and 89 are parallel and the lateral edges 91 and 93 are parallel, it should be appreciated that, in some embodiments, the oppositely facing edges may not be completely parallel or may be substantially parallel and that, in at least some embodiments, one or more of the edges may not be completely straight (e.g., one or more of the edges may have some curvature to it). Along front edge 89, member 82 forms a hinge bead 95 and a limiter bead 96. Centrally along the length of hinge bead 95, bead 95 forms a roll pin slot 94.

Referring still to FIGS. 12 and 13, proximate and parallel to rear edge 87, two hinge couplers collectively identified by numeral 85 are formed on undersurface 92. The hinge couplers 85 are spaced apart so that they are receivable between adjacent pairs of hinge couplers 40 (see again FIG. 7) at the distal ends of arm member 36. Adjacent hinge couplers 85, arm member 84 extends from under surface 92. At the end of arm member 84 proximate surface 92, the arm member 84 extends substantially perpendicular to undersurface 92 but, near a distal end 97 of arm member 84, arm member 84 curves toward the facing direction of rear edge 87. At the distal end 97, arm member 84 forms a bead (not labeled) for receiving wear pad 80.

Referring still to FIGS. 1, 12 and 13, edge flapper member 76 is a flat and rigid elongated member that includes a top surface 110, an undersurface 112, oppositely facing and parallel front and rear edges 104, 102, respectively, and first and second parallel and oppositely facing lateral edges 106 and 108, respectively. Here, it should be appreciated that in at least some embodiments the rear and front edges may not be parallel and that the first and second lateral edges also may not be parallel. It should also be appreciated that, in at least some embodiments, the front edge 104 and one or both of the lateral edges 106 and 108 may not be completely straight (e.g., each of the edges may have some curvature to it). Along rear edge 102, elongated member 98 forms a hinge channel 14 configured to receive hinge bead 95. In addition, proximate hinge channel 114, member 98 forms a limiting surface 117. Surface 117 is juxtaposed such that, when hinge bead 95 is received within channel 114 and member 99 is in a closed position (see FIG. 4), surface 117 contacts a facing surface of limiter bead 96 such that rotation of member 99 about bead 95 is restricted. When bead 95 is received in channel 114, a small gap is formed between facing edges of door member 74 and flapper member 76 such that flapper member 76 can rotate about bead 95 into an open position. In FIG. 4, rotation into the open position of flapper member 76 would be clock-wise as illustrated in phantom. A pin hole 116 is formed in member 76 proximate rear edge 102 that opens from top surface 110 into channel 114 which is aligned with slot 94 when bead 95 is received in channel 114.

Referring still to FIGS. 12 and 13, wear pad 80 is a relatively short pad member that, in cross-section, is generally C-shaped and can be slid onto the bead formed at distal end 97 of arm member 84. A friction fit maintains pad 80 at a specific position along the length of distal end 97. In at least some embodiments the wear pad 80 is spring steel. Roll pin 78 is an elongated pin member that forms an internal channel and has a slot along its length into the channel. When pin 78 is pressed into hole 116 formed by flapper member 76, the pin compresses slightly so that the pin 78 is retained within the hole 116.

To install flapper member 76 at the front edge 89 of door member 90, hinge channel 114 is aligned with bead 95 and then member 76 is slid along edge 89 until the first edges 106 and 91 of members 76 and 90 are aligned. At this point, hole 116 should be aligned with slot 95 such that, when pin 78 is forced into hole 116, a leading end of pin 78 is received within slot 95. In this way, pin 78 restricts sliding motion of flapper member 76 along bead 95 and maintains members 76 and 90 aligned.

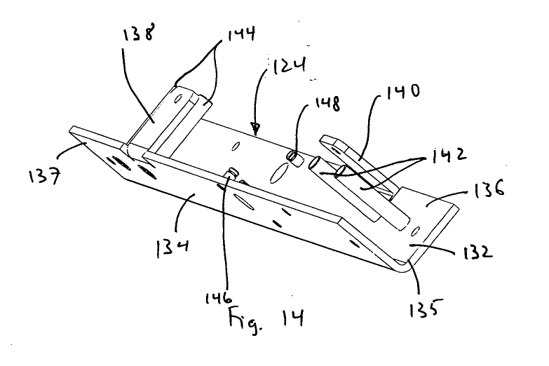

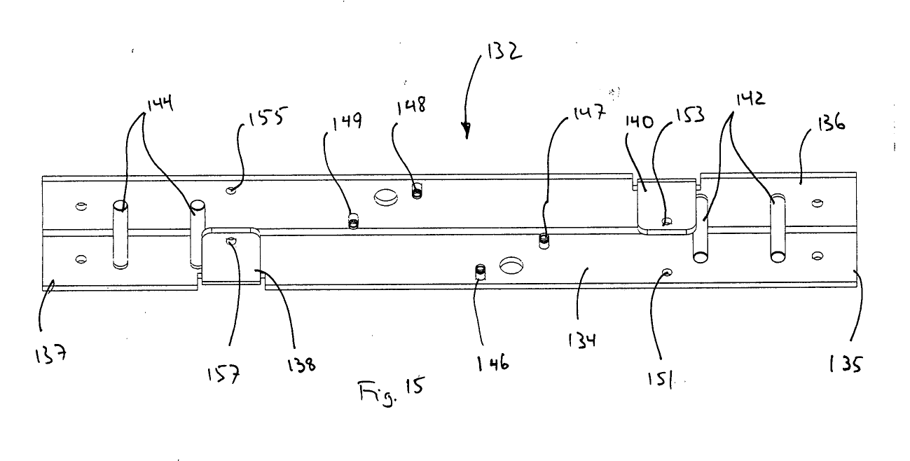

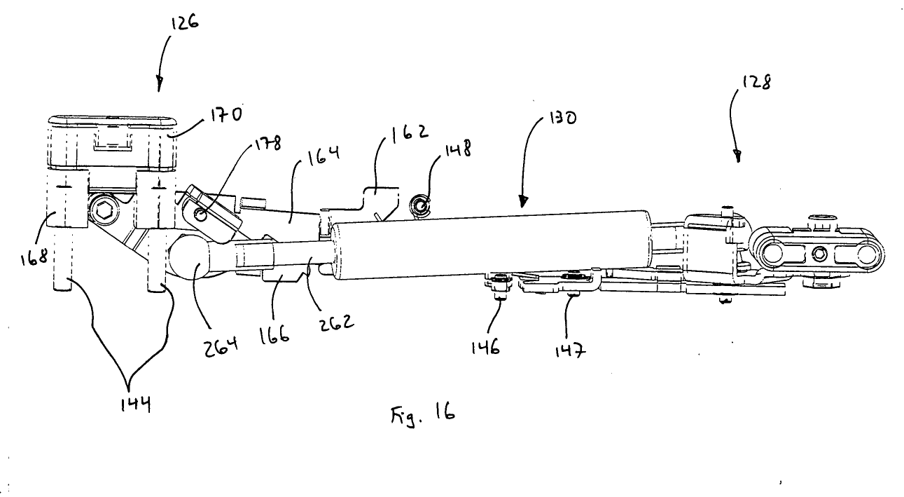

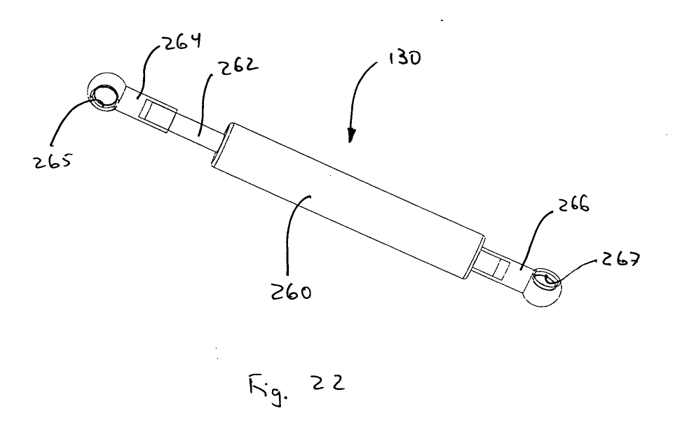

Referring once again to FIGS. 1 and 4 as well as to FIGS. 14-16, open assist assembly 32 includes a plurality of sub-assemblies including V-bracket sub-assembly 124 (see specifically FIGS. 14 and 15), a first force transfer/latch sub-assembly 126 (see FIGS. 16, 17 and 18), a second force transfer/latch sub-assembly 128 (see FIG. 16) and a gas spring sub-assembly 130 (see FIGS. 16 and 22). Referring specifically to FIGS. 14 and 15, V-bracket sub-assembly 124 includes a V-shaped bracket member 132, a first lifter pin pair 142, a second lifter pin pair 144 and first through fourth pivot pins 146, 147, 148 and 149, respectively. V-shaped bracket member 132 includes first and second rigid and substantially flat rectilinear and elongated members 134 and 136, respectively, that are integrally formed along adjacent long edges where the members 134 and 136 form a right angle when viewed in cross-section (not illustrated). The bracket 132 extends from a first end 135 to a second end 137. Along the long edge of member 134 opposite member 132, a first arm member 138 extends substantially perpendicular to member 134 and generally parallel to member 132 proximate second end 137. Similarly, proximate end 135, a second arm member 140 extends substantially perpendicular to member 136 from the long edge of member 136 opposite member 134. Referring specifically to FIG. 15, arm member 140 and member 134 form aligned dowel pin holes 153 and 151, respectively, where hole 153 is proximate a distal end of member 140 and hole 151 is proximate the edge of member 134 opposite member 132. Similarly, arm member 138 and member 136 form aligned dowel holes 157 and 155, respectively, where the holes 157 and 155 are formed proximate the distal end and the distal edge of members 138 and 136, respectively.

Referring still to FIGS. 14 and 15, proximate end 135 and generally between arm member 140 and end 135, the first lifter pin pair 142 extend substantially perpendicular to wall member 136 and parallel to wall member 134. The pair 142 are parallel to each other. Similarly, proximate end 137 and generally between end 137 and arm member 138, the second lifter pin pair 144 extend substantially perpendicular to and from wall member 134 and are parallel with member 136. The pins that form pair 144 are parallel to each other.

Referring yet again to FIGS. 14 and 15, pivot pins 146 and 147 extend substantially perpendicularly from member 134 and parallel to member 136 near a mid-section of member 134. Similarly, pins 148 and 149 extend from a mid-section of, and generally perpendicularly from, member 136.

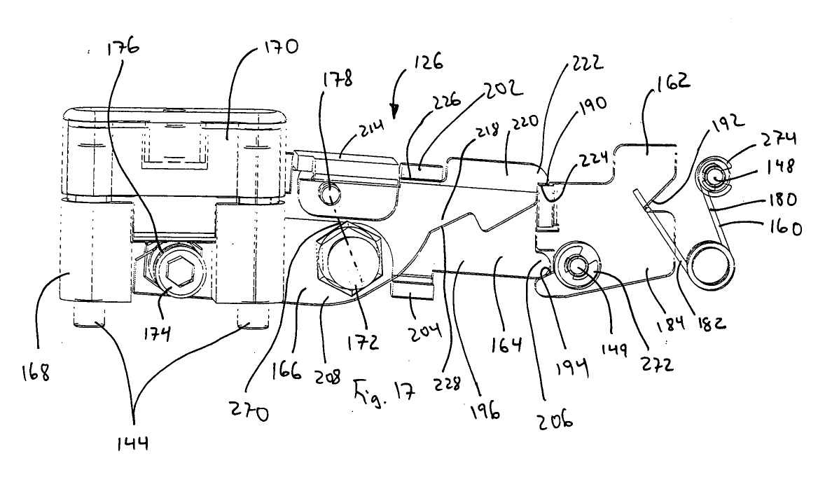

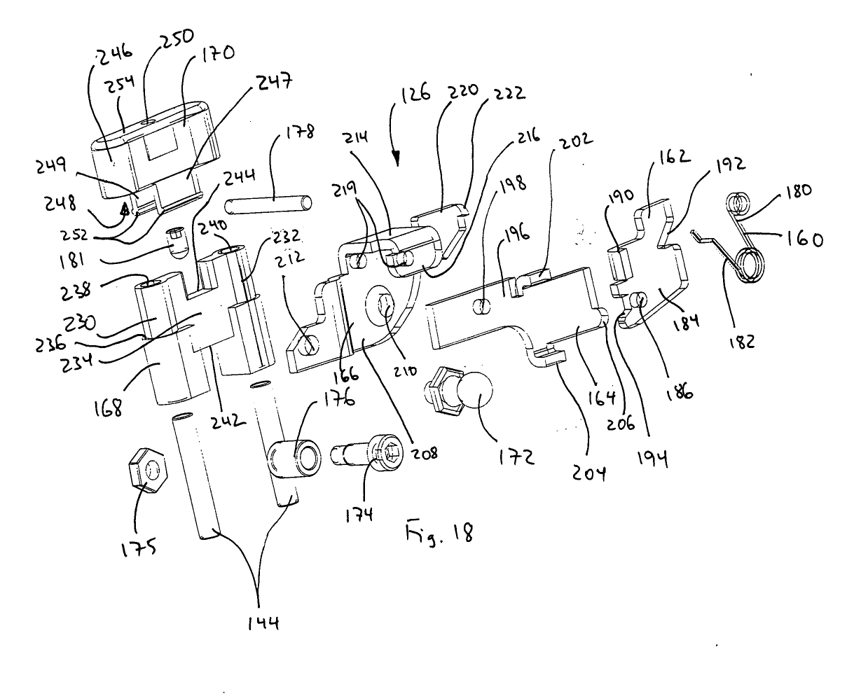

Referring now to FIG. 16, each of the first and second force transfer/latch sub-assemblies 126 and 128 is similarly constructed and operates in a similar fashion and therefore, in the interest of simplifying this explanation, only sub-assembly 126 will be described here in detail. Referring also to FIGS. 17 and 18, first force transfer/latch sub-assembly 126 includes a torsion spring 160, a catch member 162, and trigger member 164, and crank link member 166, a lifter housing member 168, a lifter pad member 170, a ball stud 172, a screw shoulder 174, a roller 176, a dowel pin 178 and an adjustment set screw 181 (see specifically FIG. 18). Spring 160 includes first and second arm members 180 and 182, respectively, that extend generally in the same direction but form an angle therebetween. When the arm members 180 and 182 are pressed toward each other, the spring is loaded and presses the arm members away from each other.

Referring still to FIGS. 17 and 18, catch member 162 includes a substantially flat and rigid body member 184 that forms a pivot hole 186. The peripheral edge of member 184 forms several functional features in the illustrated embodiment. Specifically, the peripheral edge of member 184 forms a spring recess 192 in one edge and a trigger recess 194 along an edge opposite the edge that forms spring recess 192. In addition, the edge of member 184 forms a catch surface 190 along the same edge portion that forms trigger recess 194.

Referring yet again to FIGS. 17 and 18, trigger member 164 includes a rigid and substantially flat and elongated body member 196 and first and second limiting arm members 202 and 204 that extend from opposite edges of body member 196 in the same direction and generally perpendicularly from member 196. Proximate one end, body member 196 forms a pivot hole 198. At the end opposite the end that forms pivot hole 198, a trigger nose extension 206 extends from member 196. Nose extension 206 is dimensioned so as to be receivable within recess 194 formed by member 184 (see specifically 17 in this regard). Limiting arm members 202 and 204 are located between pivot hole 198 and nose extension 206.

Referring still to FIGS. 17 and 18 crank link 166 includes a shoulder member 208, an arm member 214, a finger member 216, a neck extension member 218 and a head member 220. Should member 208 is a generally flat and rigid member that forms a stud hole 210. Arm member 214 extends substantially perpendicularly from an edge of shoulder member 208 to a distal end at which finger member 216 extends substantially parallel to shoulder member 208. Shoulder member 208 and finger member 216 form an aligned pair of pivot holes 219 that define a pivot axis (not labeled).

Referring specifically to FIG. 17, neck extension member 218 extends from one end of shoulder member 208 and has a reduced width portion defined by oppositely facing first and second limiting surfaces 226 and 228, respectively. Head member 220 extends from neck member 218. A nose member 222 extends from the distal end of head member 220 and forms a latch surface or edge 224. At an end opposite head member 220, should member 206 forms a roller hole 212.

Referring to FIGS. 17 and 18 once again, ball stud 172 includes a ball at one end and a connector component at an opposite end for connecting the ball stud to shoulder member 208 via stud opening 210. Here, although not illustrated, a screw or other mechanical fixing device may be used to secure stud 172 in hole 210. Screw shoulder 174 and associated nut 175 are used to secure roller 176 to hole 212 such that roller 176 is disposed on the same side of shoulder member 208 as ball stud 172 and so that roller 176 is free to move around the supporting surface of screw 174.

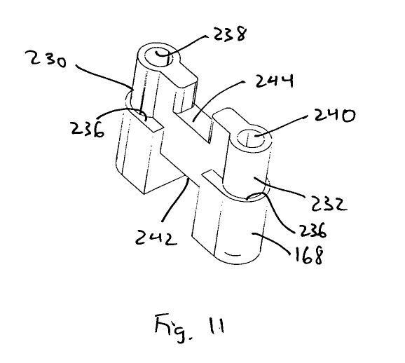

Referring still to FIGS. 17 and 18 as well as to FIG. 11, lifter housing 168 includes first and second channel forming members 230 and 232, respectively, and a central connecting member 234. As the label implies, channel forming member 230 forms an elongated channel 238 along its length. Similarly, member 232 forms an elongated channel 240 along its length. The channels 238 and 240 are parallel to each other and are dimensioned to slidably receive lifter pins 144 (see again FIGS. 14 and 15). Around external surfaces, each of members 230 and 232 forms a laterally extending limiting ridge 236. Central connecting member 234 does not extend along the entire lengths of members 230 and 232 such that first and second oppositely facing surfaces 242 and 244 are recessed from the ends of members 230 and 232. Surface 242 forms a roller bearing surface while surface 244 forms an adjustment surface that faces in a direction opposite roller bearing surface 242.

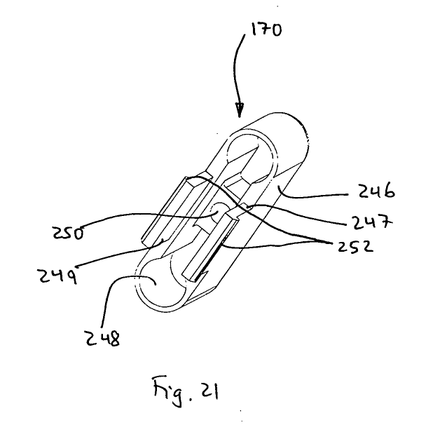

Referring to FIGS. 17 and 18 and also to FIG. 21, lifter pad member 170 includes a body member 246 and first and second arm members 247 and 249, respectively. Body member 246 forms a dual barrel channel 248 that is designed to receive the reduced dimensioned ends of channel forming members 230 and 232 in a keyed fashion. Body member 246 forms a bearing surface 254 opposite the side to which the dual barrel channel 248 opens. Body member 246 also a forms a threaded aperture or hole 250 that extends from bearing surface 254 into a central position of dual barrel channel 248 that is aligned with adjustment surface 244 when the reduced dimensioned portions of member 168 are received within channel 248. Set screw 181 has a threaded external surface and is received threadably within hole 250 so that a distal end thereof may be variably adjusted to extend out of opening 250 and into at least a portion of channel 248. Thus, when pad member 170 is received on housing member 168, the distal end of set screw 181 contacts surface 244. By rotating the set screw 181, the combined length of members 168 and 170 can be altered.

Referring still to FIGS. 17, 18 and 21, arm members 247 and 249 extend from body member 170 in a direction opposite bearing surface 254. Member 247 and 249 are generally parallel to each other and are somewhat flexible yet rigid and resilient. At distal ends of members 247 and 249, lateral lip members 252 extend in opposite directions.

Referring now to FIGS. 16 and 22, gas spring sub-assembly 130 includes a cylinder 260, a spring shaft 262 and first and second ball socket members 264 and 266, respectively. Shaft 262 extends from cylinder 260 and first ball socket member 264 is mounted to a distal end of shaft 262. Second ball socket member 266 is mounted to the end of cylinder 260 opposite shaft 262. Ball socket member 264 forms a generally spherical socket recess 265 dimensioned to rotationally receive the ball portion of ball stud 172 (see again FIG. 18). Similarly, socket member 266 forms a spherical socket 267 dimensioned to receive a ball (not labeled or illustrated) that is associated with the second force transfer/latch sub-assembly 128 (see again FIG. 16).

Next, assembly of configuration 10 will be described. To this end, referring to FIGS. 14 and 15 as well as FIGS. 17 and 18, with ball stud 172 and roller 176 mounted to crank link member 166 as described above, dowel pin 178 is used to secure both trigger member 164 and link member 166 between arm member 138 and wall member 136 such that roller 176 is positioned between the pins that form pin pair 144. To this end, member 164 is positioned between wall member 136 and member 166 with holes 198, 219, 155 and 157 aligned and then dowel pin 178 is slid through the aligned holes thereby forming a crank or pivot axis 270 (see FIG. 17 specifically). When member 164 is positioned with respect to member 166, member 164 is positioned such that neck member 218 generally resides between or aligned with the first and second limiting arms 202 and 204.

Next, catch member 184 is moved into a position such that latch surface 224 contacts catch surface 190, so that nose extension member 206 is received within recess 194 and so that pivot hole 186 receives pivot pin 149. As shown in FIG. 17, a press fit E-clip 272 may be secured to the distal end of pivot pin 149 to retain catch member 184 on pin 149.

Referring still to FIGS. 14, 15, 17 and 18, one arm 182 of spring 160 is received within recess 192 and the other arm 180 is secured to pivot pin 148 such that spring 160 is compressed between recesses 192 and 148. Here, in at the illustrated embodiment, as shown best in FIG. 17, a press fit E-clip 274 may be used to secure the second spring arm 180 to pin 148.

Referring again to FIGS. 14, 15, 17 and 18, lifter housing 168 receives pins 144 in channels 238 and 240 and is slid downward until roller bearing surface 242 contacts roller 176.

Referring to FIGS. 14-16, the assembly method described above with respect to sub-assembly 126 is performed for sub-assembly 128 in a similar fashion. After sub-assembly 128 has been installed, gas spring 120 is mounted between sub-assemblies 126 and 128. To this end, the ball studs (e.g., see 172 in FIG. 17) are securely received with the spherical sockets formed by ball socket members 164 and 166. At this point, the open assist assembly 32 which comprises all the components illustrated and described above with respect to FIGS. 14 and 16 is completely assembled except for the lifter pads (e.g., 170) and it is assumed that set screws (e.g., 181; see FIG. 18) have been installed in associated lifter pads (e.g., 170).

Next, referring to FIGS. 4 and 7, the open assist assembly 32 is slid into channel 50 formed by hinge support member 22 until the lifter housings (e.g., see 168 in FIG. 17) are aligned with the elongated oval lifter openings 52 and 54 (see also FIG. 8). Although not illustrated, screws or other mechanical fastening devices are used to secure the V-shaped bracket member 132 to hinge support 22. Next, referring to FIGS. 8 and 18, the lifter pads (e.g., 170) are aligned with openings 52 and 54 with arm members 247 and 249 extending toward the adjacent openings and then are forced down toward the openings so that the edges of the openings apply a force to the arms 247 and 249 causing them to flex inward until the lip members 252 pass through the openings 52 and 54. As the lifter pads 170 are slid through the openings 52 and 54, the reduced dimension portions of members 230 and 232 are received within the dual barrel channel 248 of lifter pad 170. Sliding motion continues until the distal end of set screw 181 contacts bearing surface 234. Once arm members 247 and 249 flex outward, the finger members 252 at the distal ends thereof will retain the filter pads (e.g., 170) connected to the larger assembly unless a large pulling force is applied thereto.

Continuing, after door assemblies 28 and 30 are assembled, the door hinge couplers 85 are aligned with hinge couplers 40 and 41 at the distal ends of arm members 36 and 38 (see FIGS. 7 and 13) and hinge pins (not labeled) are slid through the aligned hinge couplers to attach the door assemblies to hinge support member 22. Here, after the door subassemblies 28 and 30 have been attached, the wear pads 80 (see again FIGS. 12 and 13) are slid along distal ends 97 of the arm members 84 until they are aligned with the bearing surfaces 254 (see FIG. 18) of lifter pads 170 and the wear pads 80 bear there against.

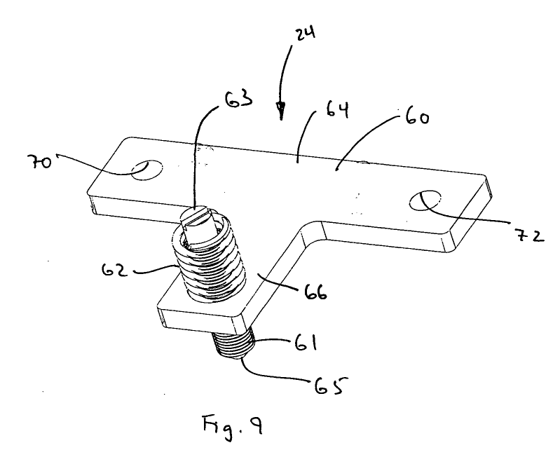

Referring to FIGS. 4, 9 and 10, the jack screw 71 is threadably received within aperture 68 and spring 62 is installed as illustrated. Continuing, referring still to FIGS. 4 and 9, with spring 62 compressed against an adjacent surface of T-shaped bracket member 60, central extending member 66, jack screw 61 and spring 62 are slid into one end of hinge support member 22 until jack screw end 63 is aligned with opening 58 (see FIG. 8). When spring 62 is released, the end of spring 62 opposite T-shaped bracket 60 is forced up against the internal surface of member 22 (see FIG. 4) thereby forcing bracket member 60 downward and forcing jack screw end 65 against the internal surface formed by member 22 opposite opening 58. T-bracket subassembly 26 is assembled in a fashion similar to that described above with respect to subassembly 24 and it is installed in the other end of member 22 so that its jack screw is aligned with opening 56 (see again FIG. 8).

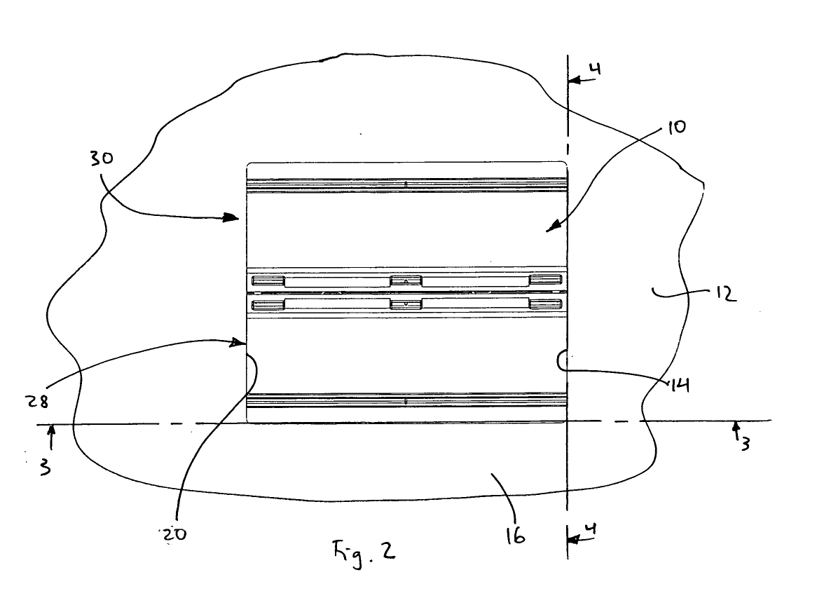

Referring to FIGS. 2, 3 and 4, to mount assembly 10 to table top member 12, assembly 10 is positioned below opening 14 formed by member 12 such that the door assemblies 28 and 30 are aligned with the opening edge surface 20 and assembly 10 is moved upward until the T-bracket members (e.g., 60) contact under surface 18. Next, screws (not illustrated) are fed through the screw holes 70 and 72 (see FIG. 9) of each T-bracket member and into the undersurface 18. At this point, depending on the relative juxtapositions of the jack screws (e.g., 61 in FIG. 4) and the T-bracket members (e.g., 60), the top surfaces of the door subassemblies 28 and 30 may or may not be completely flush with the top surface 16 of member 12. To adjust assembly 10 so that the top surfaces of the door subassemblies 28 and 30 are flush with top surface 16, the head of a screw driver can be passed through the gap between door subassemblies 28 and 30 and can be used to rotate the jack screws 61 thereby raising or lowering hinge support 22 and the door subassemblies 28 and 30 secured thereto.

In addition, it may be that after installation, one or both of the door subassemblies 28 and 30 sag within the opening 14 so that, from the rear portion of the door subassembly to the front edge portion of the door subassembly, the door subassembly is not completely horizontal. To adjust for sag, a door subassembly 28 may be rotated into an open position and a screw driver head or the like can be inserted through opening 250 and can be used to rotate set screw 181 thereby changing the overall length of lifter housing 168 and lifter pad member 170. After set screw 181 is adjusted, the door subassembly 28 is again rotated down into the position where the distal end 97 of arm member 84 contacts the bearing surface 254 of lifter pad member 170 and is supported thereby.

Next, operation of the open assist assembly 32 will be described. Referring to FIGS. 1 through 4 and also to FIG. 17, with door subassembly 28 in the closed position, the components that comprise the force transfer/latch subassembly 126 are in the orientation illustrated in FIG. 17 where latch surface 224 contacts catch surface 190 such that catch member 184 restricts rotation of crank link member 166 about axis 270. Here, roller 176 is located in a low position relative to pins 144 and therefore lifter housing member 168 and lifter pad member 170 are also in a low position so that door assembly 28 is in the closed position.

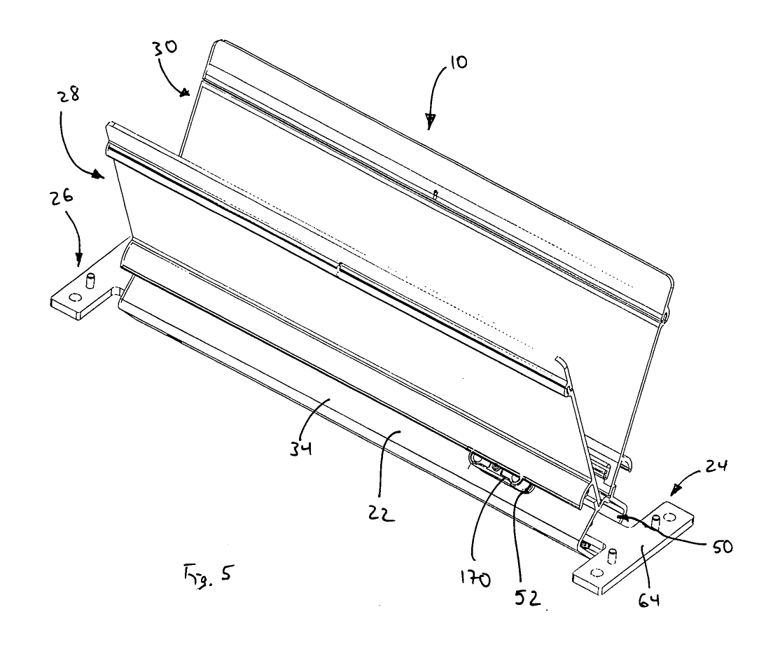

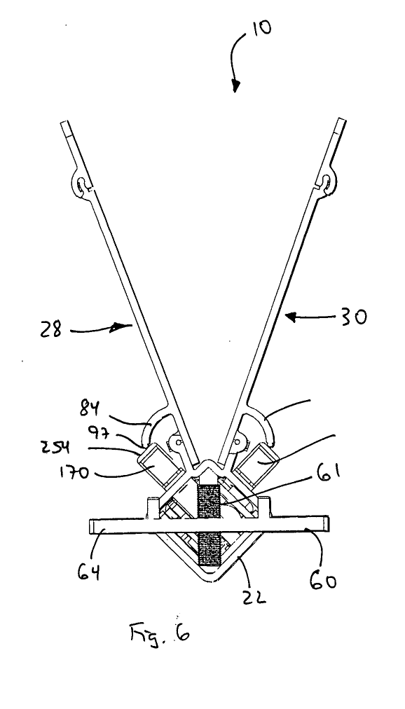

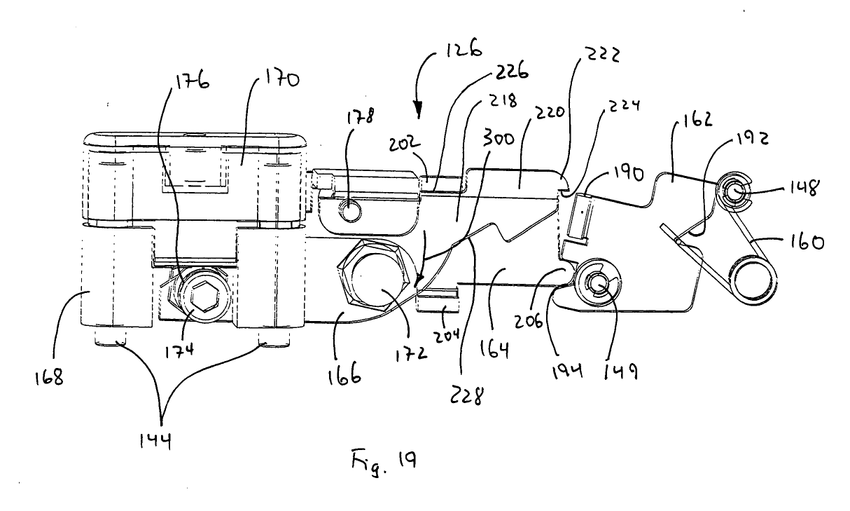

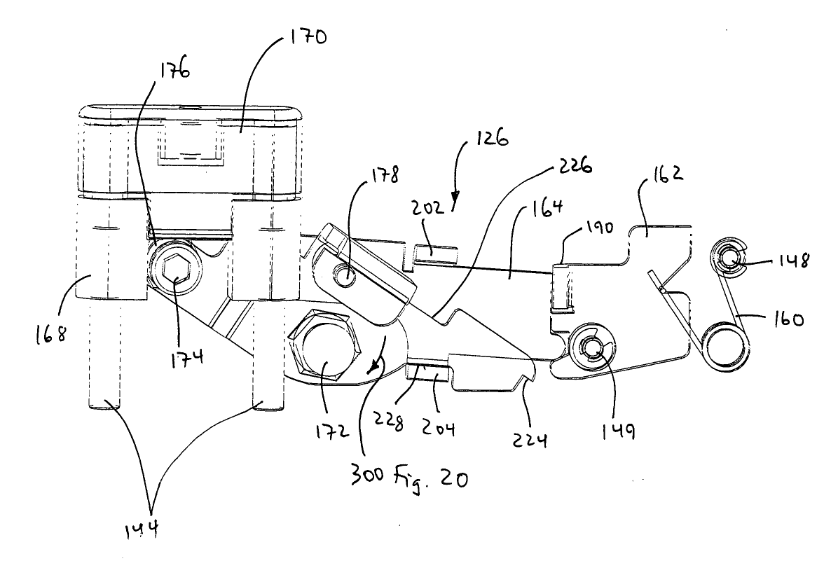

Referring now to FIGS. 4 and 19, when a person pushes down on door subassembly 28, the force of the door is transferred through arm member 84 to lifter pad 170 and housing 168 to roller 176, which causes roller 176 to move generally downward. As roller 176 moves downward, crank link member 166 rotates about pivot access 270 which causes limiting surface 226 to bear up against first limiting arm 202 to cause trigger member 164 to also rotate about pivot access 178. As trigger member 164 rotates, nose extension member 206 contacts an adjacent portion of recess 194 thereby causing catch member 184 to rotate about pin 149 and against the force of spring 160. As catch member 162 rotates, eventually, catch member 162 reaches a position such that latch surface 224 clears catch surface 190 as illustrated in FIG. 19. When door subassembly 28 is released, referring also to FIG. 16, the shaft 262 of spring 130 extends forcing crank link member 166 to rotate along the trajectory indicated by arrow 300 in FIG. 19. Referring also to FIG. 20, as link member 166 rotates, roller 176 is forced upward which in turn causes housing 168 and pad 170 to be forced upward. Referring to FIGS. 5 and 6, as pad 170 is forced upward and outward through opening 52 (see also FIG. 7), the bearing surface 254 contacts the distal end 97 of arm member 84 and forces door subassembly 28 into the open position.

In each of FIGS. 5 and 6, both door subassemblies 28 and 30 are shown in an open orientation. To close door subassembly 28, a user simply pushes down on the door subassembly 28 causing the subassembly 28 to pivot about the hinge access which applies a force through arm 84 to pad 170 which causes the components that comprise the force transfer/latch subassembly 126 to again assume the position illustrated in FIG. 17 where crank link member 166 is latched into a closed position by catch member 162.

Referring once again to FIGS. 5 and 6 and also to FIG. 16, it should be appreciated that each of the door subassemblies 28 and 30 can operate completely independently of the other door subassembly to be opened and closed and that a single spring subassembly 130 is sufficient to open either of the door subassemblies 28 or 30 independently or to open both together if both subassemblies are pressed downward simultaneously.

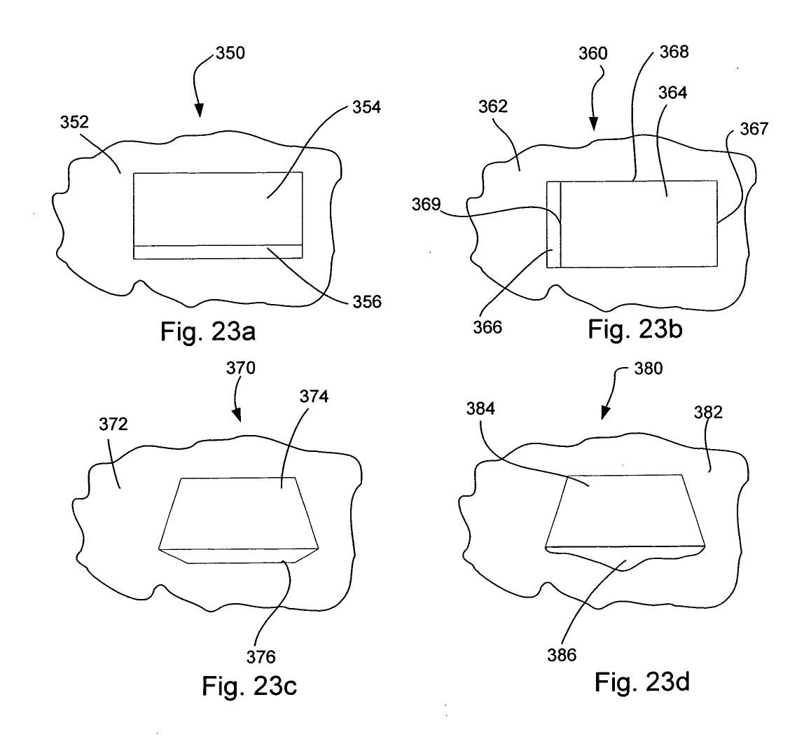

Referring now to FIGS. 23a through 23d, top plan views of other installed door assemblies that are consistent with some of inventive aspects are illustrated. In FIG. 23a, an assembly 350 is shown installed in an opening formed in a table top 352 where the assembly includes only a single door subassembly akin to subassembly 28 shown in FIGS. 12 and 13. In this embodiment, the door subassembly includes a single main door member 354 and a hinged edge flapper member 356 where edges of the door subassembly are immediately adjacent the opening edge forming surface of member 352. In FIG. 23b, an assembly 360 installed in an opening formed by a top member 362 includes a main door member 364 that has a rear edge 368 and a lateral edge 369 and a single edge flapper member 366. Here, while main door member 364 may be hinged along the rear edge 368, in this embodiment it is contemplated that edge flapper member 366 may be hinged along the lateral edge 369. Although not illustrated in other embodiments, it is contemplated that a second edge flapper member akin to member 366 may be hingedly secured to the other lateral edge 367 of door member 364.

Referring now to FIG. 23c, in this figure, an assembly 370 that is mounted within an opening formed in a table top member 372 includes a main door member 374 and a single edge flapper member 376. Main door member 374 includes substantially parallel front and rear edges and nonparallel lateral edges. Similarly, edge flapper member 376 includes substantially parallel front and rear edges and nonparallel first and second lateral edges. Here, the front edge of member 374 is secured to the rear edge of member 376 and, it is contemplated that, the rear edge of panel 374 would be generally hingedly secured to table top member 372.

In FIG. 23d, an assembly 380 is mounted with an opening formed by a table top member 382 where the assembly 380 includes a main door member 384 that is similar to main door member 374 shown in FIG. 23c but includes a flapper door member 380 that has a curved front edge that, in this embodiment, would be formed to mirror an edge formed by the surface that forms the opening edge in member 382.

One or more specific embodiments of the present invention have been described above. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Thus, the invention is to cover all modifications, equivalents, and alternatives falling within the spirit and scope of the invention as defined by the following appended claims. For example, while a gas spring is shown in the detailed embodiment above as providing open assistance for two doors, in some cases a similarly oriented spring could be used to open a single door. In addition, while one latch mechanism is illustrated for latching the open assist mechanism in a closed orientation, other mechanisms are contemplated.

To apprise the public of the scope of this invention, the following claims are made:

What is claimed is:

1. A door assembly for use with a table top member that forms a table opening, the assembly comprising:
a support member mounted to the table top member;
a first door member supported by the support member for pivotal movement between a closed position blocking at least a first portion of the table opening and an open position;
a second door member supported by the support member for pivotal movement between an closed position blocking at least a second portion of the table opening and an open position;
a single biaser supported by the support member and linked to each of the first and second door members to independently bias each of the first and second flapper members toward the open positions.

2. The assembly of claim 1 wherein each of the door members includes a bottom surface and wherein, when each of the first and second door members is in the open position, the bottom surfaces are at least in part face in substantially opposite directions.

3. The assembly of claim 2 wherein, when each of the first and second door members is in the open position, the bottom surfaces at least in part face away each other.

4. The assembly of claim 1 wherein the single biaser includes a gas spring.

5. The assembly of claim 4 wherein the single gas spring includes first and second ends that are linked to the first and second door members, respectively.

6. The assembly of claim 5 wherein the gas spring includes first and second shafts at the first and second ends where each of the shafts is extendable independent of the other of the shafts.

7. The assembly of claim 6 wherein the first door member includes a rear edge that, during movement between the open and closed positions, moves along a first trajectory, the second door member includes a rear edge that, during movement between the open and closed positions, moves along a second trajectory and the first and second shafts move along a shaft axis that is substantially perpendicular to each of the first and second trajectories.

8. The assembly of claim 7 further including first and second crank links supported for pivotal movement by the support member between the first and second shafts and the first and second flapper members, respectively, the first and second crank links pivoting about first and second crank axis to redirect shaft force from the shaft axis to the first and second trajectories.

9. The assembly of claim 8 wherein the first and second crank links include first and second latch surfaces, respectively, the assembly further including first and second catch members supported by the support member, the first and second catch members including a first and second catch surfaces, respectively, wherein, when the first and second flapper members are in the closed positions, the first and second latch surfaces contact the first and second catch surfaces thereby restricting rotation of the first and second crank links about the first and second crank axis, respectively.

10. The assembly of claim 9 wherein each of the first and second door members includes a top surface, pressure on the first door member top surface delatches the first latch surface from the first catch surface to allow the first crank link to rotate and pressure on the second door member top surface delatches the second latch surface from the second catch surface to allow the second crank link to rotate.

11. The assembly of claim 1 for use with a table top member that forms oppositely facing top and bottom surfaces wherein the support member is mounted to the bottom surface.

12. The assembly of claim 11 wherein, when the door members are in the closed positions, top surfaces of the door members are substantially flush with the top surface of the table top member.

13. The assembly of claim 1 wherein the table top opening is defined by an opening edge, the first door member includes a first peripheral edge and the second door member includes a second peripheral edge and wherein at least a portion of the opening edge is immediately adjacent at least a portion of one of the first and second peripheral edges when the door members are in the closed positions.

14. The assembly of claim 13 wherein the first peripheral edge includes substantially parallel front and rear edges and substantially parallel first and second lateral edges, the second peripheral edge includes substantially parallel front and rear edges and substantially parallel first and second lateral edges and wherein each of the front and first and second lateral edges is immediately adjacent the opening edge of the table top opening when the door members are in the closed positions.

15. The assembly of claim 14 wherein the first and second rear edges are immediately adjacent when the door members are in the closed positions.

16. The assembly of claim 15 for use with a table top member forms a top surface and each of the door members forms a top surface and wherein, when the door members are in the closed positions, the top surfaces of the door members are substantially flush with the top surface of the table top member.

17. The assembly of claim 1 wherein the support member and the biaser reside substantially within the opening.

18. A door assembly for use with a table top member that forms a table opening, the assembly comprising:
a support member mounted to the table top member;
a first door member supported by the support member for pivotal movement between a closed position blocking at least a first portion of the table opening and an open position;
a second door member supported by the support member for pivotal movement between an closed position blocking at least a second portion of the table opening and an open position;
a gas spring including first and second independently extendable shafts at first and second ends, respectively, the spring supported by the support member, the first and second shafts linked to the first and second door members to independently bias each of the first and second door members toward the open positions.

19. The assembly of claim 18 wherein the first door member includes a rear edge that, during movement between the open and closed positions, moves along a first trajectory, the second door member includes a rear edge that, during movement between the open and closed positions, moves along a second trajectory and the first and second shafts move along a shaft axis that is substantially perpendicular to each of the first and second trajectories.

20. The assembly of claim 19 further including first and second crank links supported for pivotal movement by the support member between the first and second shafts and the first and second door members, respectively, the first and second crank links pivoting about first and second crank axis to redirect shaft force from the shaft axis to the first and second trajectories.

21. A door assembly for use with a table top member and a door member, the top member including oppositely facing top and bottom surfaces and forming an opening defined by an opening edge surface, the door member for blocking at least a portion of the opening, the assembly for adjusting the position of the door member within the opening along a first trajectory that is substantially perpendicular to the top surface, the assembly comprising:
at least a first adjuster supported by at least one of the bottom surface and the opening edge surface for movement substantially along the first trajectory;
a support member supported by the first adjuster;
a door member supported by the support member;
wherein, as the adjuster moves along the first trajectory, the support member and the door member move therewith.

22. The assembly of claim 21 wherein the first adjuster is supported by the bottom surface of the top member.

23. The assembly of claim 22 further including at least a first bracket that is mounted to the bottom surface of the top member, the first adjuster supported by the first bracket.

24. The assembly of claim 23 wherein the first adjuster includes a jack bolt that is threadably received within an aperture formed by the first bracket and wherein a jack bolt axis is along the first trajectory.

25. The assembly of claim 24 wherein the support member includes a housing that forms an internal cavity having an adjustment hole and wherein the jack bolt is positioned within the internal cavity and is aligned with the adjustment hole.

26. The assembly of claim 25 further including a compression spring that forms a spring channel that receives at least a portion of the jack bolt, the spring at least partially compressed between a portion of the internal surface of the housing adjacent the adjustment hole and a facing surface of the bracket.

27. The assembly of claim 21 wherein the support member is an elongated member having first and second opposite ends, the first adjuster supporting the support member at the first end, the assembly further including a second adjuster supported by at least one of the bottom surface and the opening edge surface for movement substantially along a second trajectory that is substantially parallel to the first trajectory, the second end of the support member supported by the second adjuster.

28. The assembly of claim 27 further including first and second brackets that are mounted to the bottom surface of the table top member, the first and second adjusters supported by the first and second brackets, respectively.

29. The assembly of claim 28 wherein each of the first and second adjusters includes a jack bolt and a compression spring.

30. The assembly of claim 21 wherein the door member includes a first peripheral edge and a portion of the opening edge surface is immediately adjacent at least a portion of one of the first peripheral edge when the door member is in a closed position.

31. The assembly of claim 30 wherein the first peripheral edge includes substantially parallel front and rear edges and substantially parallel first and second lateral edges and wherein each of the front and first and second lateral edges is immediately adjacent the opening edge surface when the door member is in the closed position.

32. The assembly of claim 31 further including a second door member supported by the support member, the second door member including substantially parallel front and rear edges and substantially parallel first and second lateral edges, wherein, each of the front and first and second lateral edges of the second door member is immediately adjacent the opening edge surface when the second door member is in the closed position.

33. The assembly of claim 32 wherein the first and second rear edges are immediately adjacent when the first and second door members are in the closed positions.

34. The assembly of claim 21 wherein the support member resides substantially within the opening.

35. A door assembly for use with a table top member including oppositely facing top and bottom surfaces and forming an opening defined by an opening edge surface, the assembly comprising:
first and second brackets mounted to the bottom surface of the table top member on substantially opposite sides of the opening;
first and second adjusters supported by the first and second brackets for movement substantially along first and second substantially parallel trajectories that are substantially perpendicular to the top surface of the table top member;
an elongated support member supported at first and second ends by the first and second adjusters, respectively; and
a first door member supported by the support member, the first door member including a substantially flat top surface that is substantially parallel to the top surface of the table top member when the door member is in a closed position;
wherein, as the first and second adjusters move along the first and second trajectories, the support member and the door member move therewith within the opening.

36. The assembly of claim 35 wherein the first and second brackets are mounted to the bottom surface of the top member.

37. The assembly of claim 36 wherein the support member resides substantially within the opening.

38. The assembly of claim 35 wherein the first adjuster includes a jack bolt that is threadably received within an aperture formed by the first bracket and wherein a jack bolt axis is along the first trajectory and wherein the second adjuster includes a jack bolt that is threadably received within an aperture formed by the second bracket and wherein a jack bolt axis is along the second trajectory.

39. The assembly of claim 38 wherein the support member includes a housing that forms an internal cavity and that forms first and second adjustment holes and wherein the first and second adjuster jack bolts are positioned within the internal cavity and are aligned with the first and second adjustment holes.

40. The assembly of claim 23 wherein the first and second adjusters further include first ands second compression springs that at least partially receive the first and second jack bolts, respectively.

41. A door assembly for use with a table top member including oppositely facing top and bottom surfaces and forming an opening defined by an opening edge surface, the assembly comprising:
a support member supported by at least one of the bottom surface of the table top member and the opening edge surface;
a first door member that includes a first peripheral edges, the first door member supported by the support member for pivotal movement between closed positions in which the first door member blocks at least a portion of the table top opening and an open position, the first peripheral edge including a rear edge and non-rear edge portions; and
a second door member that includes a second peripheral edges, the second door member supported by the support member for pivotal movement between closed positions in which the second door member blocks at least a portion of the table top opening and an open position, the second peripheral edge including a rear edge and non-rear edge portions;
wherein, when the first and second door members are in the closed positions, the non-rear edge portions of each of the first and second peripheral edges are immediately adjacent portions of the first opening edge surface.

42. The assembly of claim 41 wherein each of the first and second door members includes a top surface and wherein, when the first and second door members are in the closed positions, the top surfaces of the door members are substantially flush with the top surface of the table top member.

43. The assembly of claim 41 wherein the support member is mounted to the bottom surface of the table top member.

44. The assembly of claim 41 wherein the rear edge portions of the first and second peripheral edges are immediately adjacent when the first and second flapper members are in the closed positions.

45. The assembly of claim 44 wherein each of the first and second door members includes a top surface and wherein, when the first and second door members are in the closed positions, the top surfaces of the flapper members are substantially flush with the top surface of the table top member.

46. The assembly of claim 41 wherein the first and second door members are each rectilinear and wherein each has similar dimensions.

47. The assembly of claim 41 wherein each of the door members includes a door sub-member and a flapper sub-members, the door sub-members including substantially parallel rear and front edges and hingedly linked proximate the rear edges to the support member for movement between the open and closed positions, the flapper sub-members including substantially parallel rear and front edges and hingedly linked proximate the rear edges to the front edges of the door sub-members.

48. A door assembly for use with a table top member including oppositely facing top and bottom surfaces and forming an opening defined by an opening edge surface, the assembly comprising:
a door member including a first peripheral edge including a rear edge, the door member supported proximate the rear edge by the table top member for pivotal movement between a closed position in which the door member blocks a portion of the opening and an open position;
a flapper member having a second peripheral edge, a portion of the second peripheral edge hingedly linked to a portion of the first peripheral edge such that, when the flapper member is in the closed position, the flapper member pivots with respect to the door member about the linked edge portions between a closed position in which the flapper member blocks a portion of the opening and an open position.

49. The assembly of claim 48 wherein the flapper member includes substantially parallel front and rear edges and substantially parallel first and second lateral edges and wherein the rear edge of the flapper member is linked to the first peripheral edge.

50. The assembly of claim 49 wherein the first peripheral edge includes a front edge that is substantially parallel to the rear edge and substantially parallel first and second lateral edges.

51. The assembly of claim 50 wherein the rear edge of the flapper member is hingedly linked to the front edge of the door member.

52. The assembly of claim 51 wherein, when the flapper member and the door member are in the closed positions, the first and second lateral edges of the door member, the first and second lateral edges of the flapper member and the front edge of the flapper member are immediately adjacent the opening edge surface.

53. The assembly of claim 52 wherein the opening edge surface is formed by a grommet insert.

54. The assembly of claim 52 wherein each of the door member and the flapper member includes a top surface and wherein, when the door member and the flapper member are in the closed positions, the top surfaces of the members are substantially flush with the top surface of the table top member.

55. The assembly of claim 51 wherein the dimension between the front and rear edges of the flapper member is less than one half the dimension between the front and rear edges of the door member.

56. The assembly of claim 51 wherein the dimension between the front and rear edges of the flapper member is less than one quarter the dimension between the front and rear edges of the door member.

57. The assembly of claim 51 wherein the dimension between the front and rear edges of the flapper member is approximately one tenth the dimension between the front and rear edges of the door member.

58. A door assembly for use with a table top member that includes a top surface and that forms a table opening, the assembly comprising:
a support member mounted to the table top member;
a door member supported by the support member for pivotal movement between a closed position blocking at least a first portion of the table opening and an open position;
a gas spring including a shaft, the gas spring supported by the support member and oriented so that the shaft moves along a shaft axis that is substantially parallel to the top surface of the table top member, the shaft linked to the first flapper member to bias the door member toward the open position.

59. The assembly of claim 58 wherein the door member includes a rear edge that, during movement between the open and closed positions, moves along a first trajectory that is substantially perpendicular to the shaft axis.

60. The assembly of claim 59 further including a first crank link supported for pivotal movement by the support member between the shaft and the door member, the first crank link pivoting about a first crank axis to redirect shaft force from the shaft axis to the first trajectory.

61. The assembly of claim 60 wherein the first crank link includes a first latch surface, the assembly further including a first catch member supported by the support member, the first catch member including a first catch surface, wherein, when the door member is in the closed position, the first latch surface contacts the first catch surface thereby restricting rotation of the first crank link about the first crank axis.

62. The assembly of claim 61 wherein the door member includes a top surface, pressure on the door member top surface delatches the first latch surface from the first catch surface to allow the first crank link to rotate.

63. A door assembly for use with a table top member that forms a table opening, the assembly comprising:
a support member mounted to the table top member;
a door member supported by the support member for pivotal movement between a closed position blocking at least a first portion of the table opening and an open position;
a lifter assembly supported by the support member for movement along a first trajectory, the lifter assembly including:
a first lifter member including a first surface;
a second lifter member including a second surface that contacts and supports the door member, the second lifter member supported by the first lifter member so that the first and second surfaces substantially face in opposite directions; and
a lifter adjuster for adjusting the position of the first lifter member with respect to the second lifter member so that a dimension between the first and second surfaces is adjustable.

64. The assembly of claim 63 wherein the lifter adjuster is a set screw.

65. The assembly of claim 63 wherein the lifter assembly further includes at least a first pin mounted to the support member wherein the first and second lifter members are mounted to the first pin to slide there along between a first position in which the door member is in the closed position and a second position in which the second surface forces the door member into the open position.

66. A door assembly for use with a table top member that forms a table opening, the assembly comprising:
a support member mounted to the table top member;
a substantially flat door member having a peripheral edge, the door member supported by the support member proximate a portion of the peripheral edge for pivotal movement between a closed position blocking at least a first portion of the table opening and an open position; and
an adjuster supported by the support member and including a distal end, the adjuster adjustable to alter the position of the distal end along a first trajectory, the distal end contacting and supporting the door member at an angle with respect to the first trajectory that is dependent upon the position of the distal end.
